(19) United States
(12) Patent Application Publication
(10) Pub. No.: US 2006/0129486 A1
(43) Pub. Date: Jun. 15, 2006

(54) Quantum cash system and quantum cash apparatus

(76) Inventors: Kenji Ohkuma, Yokohama-shi (JP); Mikio Fujii, Fuchu-shi (JP); Kouichi Ichimura, Yokohama-shi (JP); Hayato Goto, Kawasaki-shi (JP); Kentaro Torii, Yokohama-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/348,321

(22) Filed: Feb. 7, 2006

Related U.S. Application Data
(63) Continuation of application No. PCT/JP05/14359, filed on Jul. 29, 2005.

(30) Foreign Application Priority Data
Jul. 30, 2004 (JP) 2004-224447

(51) Int. Cl. G06Q 40/00

(52) U.S. Cl. 705/44

(57) ABSTRACT

An aspect of the present invention relates to a quantum cash system and a quantum cash apparatus which can inhibit even forgery in which quantum verification information is transformed using inverse transformation data, thus improving security. In order to allow quantum cash to be validly used, a quantum cash holding apparatus outputs one of the inverse transformation data and then inhibits the output of the other inverse transformation data in a verification list. This prevents the outflow of the other inverse transformation data, required for the forgery of the quantum cash.

### CROSS-REFERENCE TO RELATED APPLICATIONS

This is a Continuation Application of PCT Application No. PCT/JP2005/014359, filed Jul. 29, 2005, which was published under PCT Article 21(2) in Japanese.

This application is based upon and claims the benefit of priority from prior Japanese Patent Application No. 2004-224447, filed Jul. 30, 2004, the entire contents of which are incorporated herein by reference.

### BACKGROUND OF THE INVENTION

1. Field of the Invention

The present invention relates to a quantum cash system and a quantum cash apparatus that circulate quantum cash that is secure from forgery on the basis of a no-cloning theorem, and in particular, to a quantum cash system and a quantum cash apparatus that can inhibit even forgery in which quantum verification information is transformed using inverse transformation data, thus improving security.

2. Description of the Related Art

Quantum cash, invented by Wiesner in 1969, is known. Here, the quantum cash is information on a serial number and a face value as well as verification data recorded as a quantum state and added to the information.

The quantum state cannot be cloned without original data and is thus guaranteed to be secure from cloning. This is generally called the no-cloning theorem.

On the other hand, the quantum state is verified to be correct when compared with the identical quantum state and found to match it. When different quantum states are compared with each other, a mismatch is correctly verified at a specified probability with a match incorrectly verified at the remaining probability. Accordingly, by using a large number of quantum states to reduce the probability of errors, it is possible to ensure the result of the verification indicating that the quantum states are different from each other. Further, since a quantum state can be generated from verifying data, quantum cash can be verified on the basis of the verifying data (Jpn. Pat. Appln. KOKAI Publication No. 2001-7798 describes an example of verification of the quantum state). In a well-known example of the quantum state, the polarized state of a single photon is utilized as a base.

In a desirable utilization form of quantum cash, all shops except the one that issued quantum cash can verify the quantum cash as in the case of, for example, banks. That is, desirably, an agency that is different from an issuer can carry out verification and settlement for the issuer.

However, verification requires verification data or a quantum state generated from the verification data. However, when verification data or its quantum state is distributed to agencies, the distribution destinations can clone the quantum cash. This allows various illegal acts to be committed. For example, in a possible illegal act, cloned quantum cash may be claimed to be the one presented by the user. Further, even if the distribution destination has no cloning functions, it can conspire with another shop to claim a verifying quantum state to be the quantum cash presented by the user. The issuer cannot expose these illegal acts. In fact, not all verifying functions are sufficiently reliably operated. Thus, at present, there are no effective mechanisms for carrying out verification on behalf of the issuer.

On the other hand, in order to make such an effective mechanism, a quantum cash system has been proposed as a prior application that had not been laid open to the public before the present application was filed; the quantum cash system ensures security while separating a function for issuing quantum cash from a function for verifying quantum cash (Jpn. Pat. Appln. KOKAI Publication No. 2003-432227).

However, further examinations by the inventor et al. of the prior application indicate that the prior application is disadvantageous when a quantum verifying apparatus conspires with a quantum cash holding apparatus that has paid quantum cash, though this is almost impossible. Specifically, it is logically possible that quantum cash is forged by transforming quantum verification information in the quantum verifying apparatus using inverse transformation data remaining in the quantum cash holding apparatus. In this case, the quantum verification information and inverse transformation data themselves which are used for forgery are both genuine. Accordingly, when the forged quantum cash is paid to the quantum cash verifying apparatus before validly paid quantum cash is settled for a quantum cash issuing apparatus, another quantum cash verifying apparatus cannot spot the quantum cash as a forgery and accepts the invalid payment.

It is an object of the present invention to provide a quantum cash system and a quantum cash apparatus that can inhibit even forgery in which quantum verification information is transformed using inverse transformation data, thus improving security.

### BRIEF SUMMARY OF THE INVENTION

According to a first aspect of the present invention, there is provided a quantum cash system comprising: a quantum cash issuing apparatus which issues quantum cash including a first quantum state corresponding to original data indicating at least the amount of money, a plurality of pieces of quantum verification information including second quantum states obtained by individually transforming the first quantum state on the basis of a plurality of transformation data, the quantum verification information being used to verify the first quantum state, and a verification list having a plurality of inverse transformation data used to inversely transform the quantum verification information in association with the transformation data and identifiers that can identify the inverse transformation data; a quantum cash holding apparatus which holds the quantum cash and the verification list and which can output the quantum cash and one of the inverse transformation data in the verification list; and a quantum cash verifying apparatus to which the identifier is assigned and which, upon receiving the quantum cash, inverse transformation data, and identifier from the quantum cash holding apparatus, can verify the first quantum state of the quantum cash on the basis of first quantum information obtained by transforming second quantum information of the quantum verification information using the inverse transformation data, wherein the quantum cash holding apparatus comprises: an output device configured to output of one of the inverse transformation data; and an output inhibiting device configured to inhibit output of the other inverse transformation data in the verification list.

According to a second aspect of the present invention, there is provided a quantum cash issuing apparatus used in a quantum cash system, the quantum cash system comprising: the quantum cash issuing apparatus which issues quantum cash including a first quantum state corresponding to original data indicating at least the amount of money, a plurality of pieces of quantum verification information including second quantum states obtained by individually transforming the first quantum state on the basis of a plurality of transformation data, the quantum verification information being used to verify the first quantum state, and a verification list having a plurality of inverse transformation data used to inversely transform the quantum verification information in association with the transformation data and identifiers that can identify the inverse transformation data; a quantum cash holding apparatus which holds the quantum cash and the verification list and which can output the quantum cash and one of the inverse transformation data in the verification list; and a quantum cash verifying apparatus to which the identifier is assigned and which, upon receiving the quantum cash, inverse transformation data, and identifier from the quantum cash holding apparatus, can verify the first quantum state of the quantum cash on the basis of first quantum information obtained by transforming second quantum information of the quantum verification information using the inverse transformation data, wherein the quantum cash issuing apparatus further comprises: a first receiving device configured to receive an identifier and a quantum verification information request from the quantum cash verifying apparatus in connection with verification of the quantum cash or a reservation for the verification; a verification information distributing device configured to distribute, to the quantum cash verifying apparatus, quantum verification information transformed using transformation data corresponding to inverse transformation data identified by the identifier.

Therefore, according to the first aspect of the present invention, in order to allow the quantum cash to be validly used, the quantum cash holding apparatus outputs one of the inverse transformation data and then inhibits the output of the other inverse transformation data in the verification list. This prevents the outflow of the other inverse transformation data, required for forgery of the quantum cash. It is thus possible to inhibit even forgery in which the quantum verification information is transformed using the inverse transformation data, thus improving security.

The second aspect of the present invention not only produces the effects of the first aspect but also uses the arrangement that distributes the quantum verification information to only the quantum cash verifying apparatus that actually verifies the quantum cash and not to other quantum cash verifying apparatuses. This makes it possible to further improve security.

### BRIEF DESCRIPTION OF THE SEVERAL VIEWS OF THE DRAWING

FIG. 1 is a diagram (1) showing the whole quantum cash system according to a first embodiment of the present invention.

FIG. 2 is a diagram (2) showing the whole quantum cash system according to the first embodiment.

FIG. 3 is a diagram showing the functional blocks of a quantum cash issuing apparatus 1.

FIG. 4 is a diagram showing the functional blocks of a quantum cash verifying apparatus.

FIG. 5 is a diagram showing the probability of detection of a quantum state in a table form.

FIG. 6 is a diagram showing an example of generation of original data.

FIG. 7 is a diagram showing a quantum cash generating section 12 according to the present specific example.

FIG. 8 is a diagram showing the internal configuration of a quantum state generating section 41.

FIG. 9 is a diagram showing an example of the relationship between an identifier, transformation data, and inverse transformation data.

FIG. 10 is a diagram showing the configuration of a quantum verification information generating section 13.

FIG. 11 is a diagram showing an example of a quantum cash holding apparatus.

FIG. 12 is a diagram showing a quantum cash verifying apparatus 2-1.

FIG. 13 is a diagram showing the functional blocks of a setting section 15 of the quantum cash verifying apparatus 1.

FIG. 14 is a diagram showing a function for electronic information transformation provided in the quantum cash verifying apparatus 2-1.

FIG. 15 is a diagram showing a verification using a + base measurement result and an × base measurement result.

FIG. 16 is a schematic diagram showing the configuration of a quantum cash holding apparatus applied to a quantum cash system according to a third embodiment of the present invention.

FIG. 17 is a schematic diagram showing the configuration of a quantum cash issuing apparatus applied to a quantum cash system according to a fourth embodiment of the present invention.

FIG. 18 is a sequence diagram illustrating operations according to the fourth embodiment.

FIG. 19 is a sequence diagram illustrating operations of a quantum cash system according to a fifth embodiment of the present invention.

FIG. 20 is a sequence diagram illustrating operations according to the fifth embodiment.

### DETAILED DESCRIPTION OF THE INVENTION

The embodiments of the present invention will be described below in detail.

A quantum state means a state containing the undulating nature of elementary particles such as electrons or photons and corresponding to the super-imposition of a plurality of basic states of the elementary particles. Further, the quantum state has the nature that measurements enable the obtainment of information on only a part of the state, the nature that measurements vary the state, and the nature that a measured value is not uniquely defined. These natures characterized the quantum state such that an unknown quantum state without any design information cannot be made while maintaining its original state. This characteristic corresponds to the above quantum no-cloning theorem.

Quantum cash comprises the value of itself as in the case of checks, securities, and bills as well as information having a quantum state indicating that this quantum cash is correct. The value need not necessarily be money.

Quantum verification information comprises, as verifying information, a quantum state used to check whether or not the quantum cash is genuine.

The validity of the quantum state can only be verified by checking whether or not a quantum state to be verified perfectly matches a verifying quantum state. That is, the presence of two identical quantum states makes it possible to determine that the quantum state to be verified is valid.

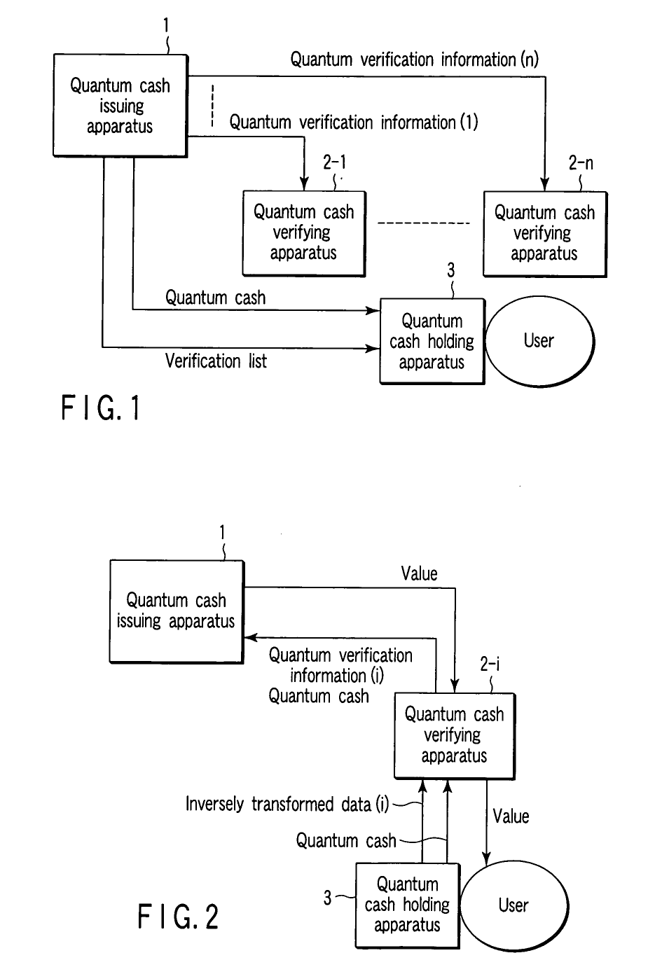

FIGS. 1 and 2 show the whole quantum cash system according to the present embodiment. This quantum cash system can be roughly divided into a quantum cash issuing function, a quantum cash advance function, and a quantum cash settling function. FIG. 1 shows the quantum cash issuing function. FIG. 2 shows the quantum cash advance function and the quantum cash settling function. With the advance, on behalf of the issuer of the quantum cash, an agent receives the quantum cash to supply a value as a consideration. With settlement, the issuer of the quantum cash supplies the value to the advance payer and collects the quantum cash.

The system comprises a quantum cash issuing apparatus 1, n quantum cash verifying apparatuses 2-1 to 2-n (n is an integer equal to or larger than 2), and a quantum cash holding apparatus 3.

The quantum cash issuing apparatus 1 issues quantum cash to a user, issues various pieces of information relating to verification of the quantum cash (verification list and quantum verification information (1) to (n)), and settles the issued quantum cash (collection of quantum verification information (i) and quantum cash).

On the other hand, the quantum cash verifying apparatuses 2-1 to 2-n makes payment for the quantum cash issuing apparatus 1. Uniquely identifiable identifiers (for example, an apparatus unique number and an apparatus name) are assigned to the quantum cash verifying apparatuses 2-1 . . . 2-n.

The quantum cash holding apparatus 3 can hold the quantum cash and verification list issued by the quantum cash issuing apparatus 1. The quantum cash can further output the quantum cash and one of the inverse transformation data in the verification list to the quantum cash verifying apparatus 2-i (where 1≦i≦n). The quantum cash holding apparatus 3 has a function for outputting one of the inverse transformation data and then inhibiting the output of the other inverse transformation data in the verification list.

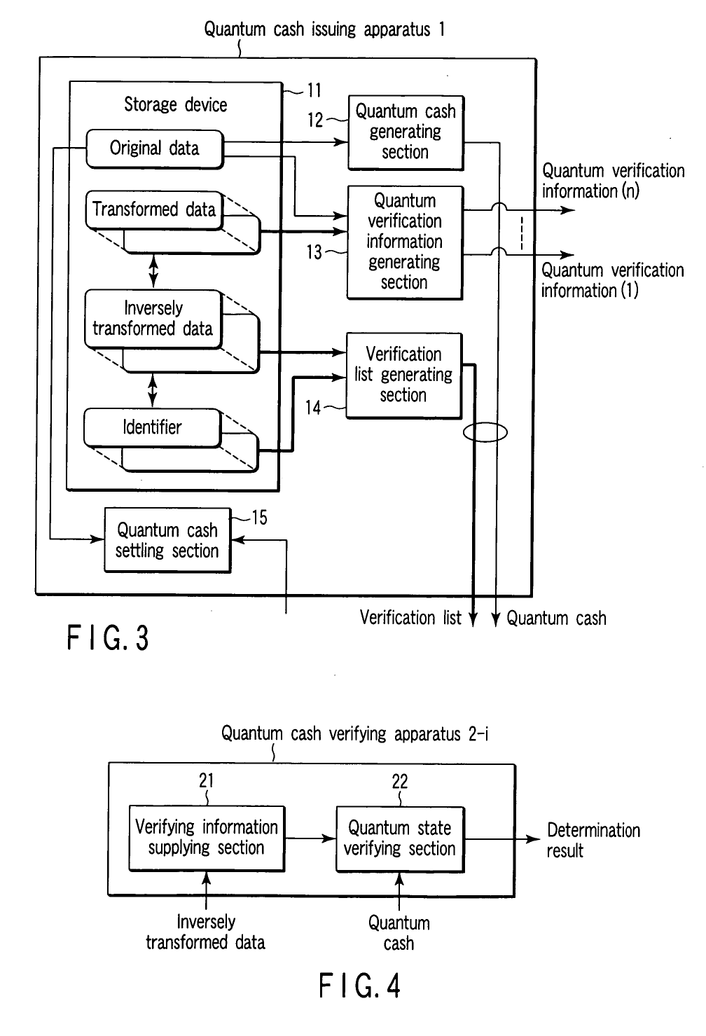

FIG. 3 is a diagram showing the functional blocks inside the quantum cash issuing apparatus 1.

The quantum cash issuing apparatus 1 generates quantum states. The quantum cash issuing apparatus 1 comprises a storage section that original data managed in secret, identifiers assigned to the quantum cash verifying apparatuses 2-1 . . . 2-n, transformation data associated with the respective identifiers, and inverse transformation data corresponding to the transformation data.

Instead of using the storage section 11, the administrator of the quantum cash issuing apparatus 1 may input these data as required. However, particularly the original data is utilized during not only the issuance but also the collection of the quantum cash. Accordingly, it is important to use an appropriate method to store the original data in secret so that the storage will not be forgotten.

Here, the transformation data and inverse transformation data are parameters provided to a predetermined reversible transforming system (the reversible transforming system is generally called unitary transformation). Transformed information is obtained by executing a predetermined unitary transformation on the original data on the basis of the transformation data. The original data is obtained by executing the unitary transformation on the transformed information on the basis of the inverse transformation data. That is, the inverse transformation data acts on the predetermined unitary transformation so as to cancel the operation of the transformation data.

A quantum cash generating section 12 generates a quantum state from the original state and quantum cash that holds this quantum state.

A quantum verification information generating section 13 generates a quantum state from the original data, and on the basis of each transformation data, individually applies the predetermined unitary transformation to the quantum state to generate quantum verification information that individually holds each quantum state obtained. Here, the quantum cash generating section 12 is separate from the verification information generating section 13. However, they may be composed of the same apparatus. In this case, to generate quantum cash, transformation data “0” must be provided to the unitary transformation, that is, a transformation must be carried out.

A verification list generating section 14 generates a verification list that associates each identifier with the corresponding inverse transformation data.

The quantum cash issuing apparatus 1 issues the quantum cash holding apparatus 3 holding a set of the quantum cash and verification list to a user. The issuance is carried out only once for one quantum cash. Further, the quantum cash issuing apparatus 1 supplies each of the quantum cash verifying apparatuses 2-1 . . . 2-n with quantum verification information corresponding to each identifier. That is, the quantum cash verifying apparatuses 2-1 . . . 2-n comprise, for the quantum cash, different pieces of quantum verification information unique to the quantum cash verifying apparatuses 2-1 . . . 2-n.

For processes including the issuance of the quantum cash, the supply of quantum verification information, the verification of the quantum cash, and the settlement of the quantum cash, security can be verified by utilizing an encryption technique for the mutual authentication between two parties communicating information. Specifically, a public key encryption technique such as RSA cipher is available. This technique, an authenticated party generates a pair of a public key and a secrete key and lays the public key open to the public. For authentication, an authenticating party generates a random number and carries out encryption using the public key. The authenticating party sends the encrypted random number to the authenticated party. The authenticated party uses the secret key to decode the encrypted random number. The authenticated party then returns the value obtained to the authenticating party. If the returned value matches the original random number, the authenticating party confirms the validity of the authenticated party. The encryption technique is described in the document “Tatsuaki OKAMOTO and Hiroshi YAMAMOTO, “Modern encryption”, Sangyo Tosho, 1997”.

After the user utilizes the issued quantum cash, a quantum cash setting section 15 checks whether or not the quantum cash verifying apparatus 2-i (i is one of 1 to n) for which the quantum cash has been utilized has acted validly for the user and carries out settlement, in order to settle the value paid by the quantum cash verifying apparatus 2-i for the user.

It is assumed that the user has received the quantum cash holding apparatus 3 from the quantum cash issuing apparatus 1 configured as described above. When realizing the quantum cash in the quantum cash holding apparatus 3, the user selects one of the n quantum cash verifying apparatuses 2-1 to 2-n. The user then selects one of the inverse transformation data in the verification list which corresponds to the selected quantum cash verifying apparatus 2-i. The quantum cash holding apparatus 3 supplies and outputs the selected inverse transformation data to the quantum cash verifying apparatus 2-1 together with the quantum cash. Subsequently, the quantum cash holding apparatus 3 inhibits the other inverse transformation data from being output.

FIG. 4 is a diagram showing the functional blocks inside one of the quantum cash verifying apparatuses 2-1 . . . 2-n. For simplification of the description, the description below will focus on the quantum cash verifying apparatus 2-i.

A verifying information supply section 21 applies a predetermined unitary transformation to pre-supplied quantum verification information (i) for the quantum cash verifying apparatus 2-i on the basis of the inverse transformation data for the quantum cash verifying apparatus 2-i supplied by the user. The verifying information supply section 21 supplies the quantum state obtained to the quantum cash verifying section 22.

The quantum cash verifying section 22 checks whether or not the quantum state of the quantum cash supplied by the user matches the quantum state supplied by the verifying information supply section 21. If the quantum states match, the quantum cash verifying section 22 can determine that this quantum cash is valid. If the quantum states do not match, the quantum cash verifying section 22 can determine that this quantum cash is invalid. As is well known, if the quantum states are determined to match, the respective original quantum states are obtained (two identical quantum states). However, if the quantum states do not match, the original quantum states cannot be obtained.

If the quantum cash verifying apparatus 2-i can determine that the user's quantum cash is valid, the consideration set for the quantum cash is provided to the user in exchange for the quantum cash supplied by the user. For the consideration, the specific amount of money may be printed on the quantum cash. Alternatively, the quantum cash issuing apparatus 1 may communicate the value of the quantum cash to the user and to each of the quantum cash verifying apparatuses 2-1 . . . 2-n so that the consideration is based on the commonly recognized value.

After the advance process is finished between the user and the quantum cash verifying apparatus 2-1, a setting process is executed between the quantum cash verifying apparatus 2-i and the quantum cash issuing apparatus 1 at an appropriate time. The setting process is executed in association with the advance process in which the quantum cash verifying apparatus pays the value on behalf of the quantum cash issuing apparatus 1, which should inherently pay the consideration for the quantum cash. Specifically, the settling process refers to a process in which the quantum cash issuing apparatus 1 pays the value to the quantum cash verifying apparatus 2-i as well as a process for verifying that the quantum cash verifying apparatus 2-i is not committing an illegal act.

The quantum cash verifying apparatus 2-i requests the quantum cash issuing apparatus 1 to carry out settlement on the basis of the set of two quantum states resulting from the verification.

If the above quantum cash setting section 15 verifies and determines the validity, the quantum cash issuing apparatus 1 considers that the user has been provided with the consideration set for the quantum cash. The quantum cash issuing apparatus 1 provides the value for which the advance has been paid.

The above description is easily understood by taking the case of banks and considering the quantum cash to be a deposit bond, the quantum cash issuing apparatus to be an issuing bank, and the quantum cash verifying apparatuses to be branch offices different from the issuing bank, and the user to be a depositor. According to such an embodiment, even banks different from the one in which the user has deposited money allow the quantum cash to be realized while concealing the transformation data from the quantum cash verifying apparatuses.

In the above embodiment, the same apparatus executes the process of issuing the quantum cash and the process of settling the quantum cash. However, of course, separate apparatuses may execute these processes. Importantly, the issuing process and the settling process are executed individually by one or more apparatuses, but the advance process is executed individually by a plurality of apparatuses.

Further, in the above embodiment, the verification information on the quantum cash is pre-distributed to all the quantum cash verifying apparatuses 2-1 to 2-n. The present invention is not limited to this. When the quantum cash is verified, the user may request the verifying apparatus (for example, 2-1) to send verification information on demand. This method may be effective for reducing the total amount of communication to improve security.

Furthermore, the process of sending verification information on demand may be reserved before verification using the Internet or the like, to reduce the time required for the verification. This method can utilize the mutual authentication system using public key encryption.

Moreover, it is possible to allow the reservation for verification to be cancelled to improve convenience. With this method, the quantum cash verifying apparatus returns the quantum state to the quantum cash issuing apparatus, which then confirms its genuineness. Consequently, the canceling process can be safely completed. The on-demand request and the reservation for it will be described in detail in a fourth and fifth embodiments.

The present embodiment, described above, maintains security for the quantum cash issuing apparatus 1 and enables an arbitrary one of the quantum cash verifying apparatuses 2-1 . . . 2-n to verify the quantum cash supplied by the user. This makes it possible to provide a system that can be easily utilized by the user, the owner of the quantum cash.

Further, in order to allow the quantum cash to be validly used, the quantum cash holding apparatus 3 outputs one of the inverse transformation data and then inhibits the output of the other inverse transformation data in the verification list. This prevents the outflow of the other inverse transformation data, required for the forgery of the quantum cash. It is thus possible to inhibit even the forgery in which the quantum verification information is transformed using the inverse transformation data, thus improving security.

### Second Embodiment

Now, a second embodiment of the present invention will be described below. The present embodiment will give a specific example of the first embodiment in which the polarizing direction of a single photon is utilized as a quantum state. Description will be given of examples of the configurations of the above sections.

As is well known, the single photon can be generated by sufficiently reducing the intensity of laser light using an attenuator. Further, as is well known, the polarizing direction of the single photon can be arbitrarily controllably switched depending on the magnitude of a voltage applied to a polarizer that uses an electro-optical effect element when the photon is passed through the polarizer.

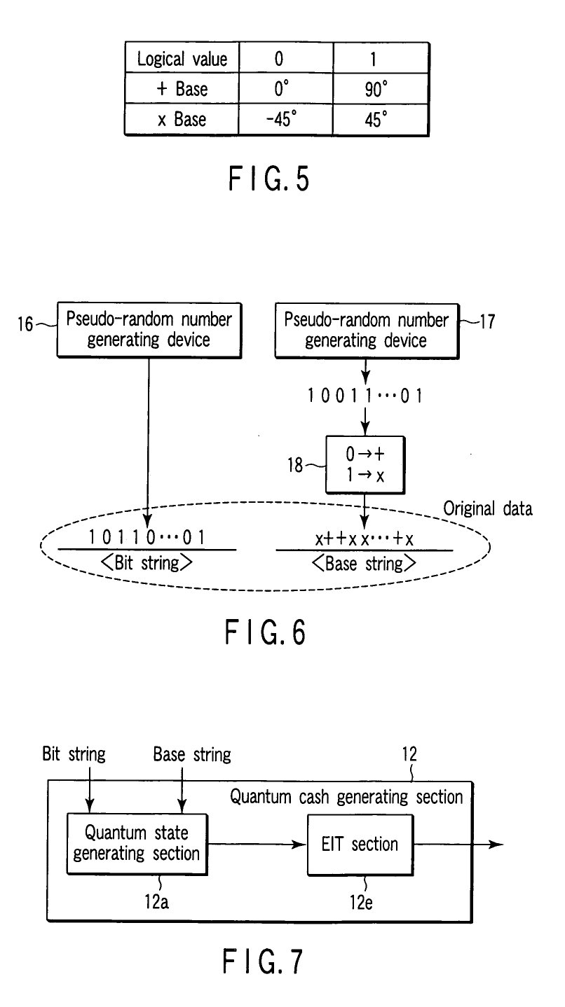

In the present specific example utilizes two bases: a set of linearly polarized lights having a horizontal (0°) and vertical (90°) polarizing directions and a set of linearly polarized lights having polarizing directions of 45° and −45°. In this case, the former set is called a plus base, while the latter is called a cross base. Then, for the plus base, the polarizing direction of 0° is defined as a logical value 0, while the polarizing direction of 90° is defined as a logical value 1. For the cross base, the polarizing direction of −45° is defined as a logical value 0, while the polarizing direction of 45° is defined as a logical value 1. The plus base and the cross base have a conjugative relationship and can take either the logical value 0 or 1. Accordingly, four quantum states can be shown for the single photon. This relationship is shown in FIG. 5 as a table.

Further, for the retention of a quantum state generated on basis of the polarizing direction of a photon, for example, a technique called Electromagnetically Induced Transparency (EIT) is known which allows the single photon to enter rare earth ions (Pr³⁺) dispersed in an oxide crystal (Y₂SiO₅) to record the polarizing direction of the photon in the solid. The present specific example also utilizes EIT. EIT is described in the document [K. Ichimura, “Frequency Domain Quantum Computer with Solid-State Structures”, Toshiba review, vol. 57, No. 9, (2002)]. A solid that holds a quantum state using EIT will be called an EIT solid below.

Original data is composed of a set of a random bit string of a sufficient length and a base string that is random in association with the bits of the bit string. FIG. 6 shows an example of generation of original data.

Two random number generating apparatuses 16 and 17 are not correlated with each other in connection with generation of random numbers. The random number generating apparatus 16 generates a random number 0/1 of a predetermined length which constitutes a bit string of original data. On the other hand, the random number generating apparatus 17 generates a random number 0/1 of the same length as the predetermined length of the above random number. In the random numbers 0/1 generated, a + (base) is assigned to 0, whereas an × (base) is assigned to 1. In the result of the assignment, a predetermined length of the symbols + and × are defined as a base string. The set of the bit and base strings generated as described above is defined as original data.

For the original data, a serial number is associated with a face value provided for the original data in order to distinguish this original data from the other original data. The original data is thus stored in the storage apparatus 11 and managed in secret. The serial number and the face value may be stored in association with each other when the quantum cash is issued to the user.

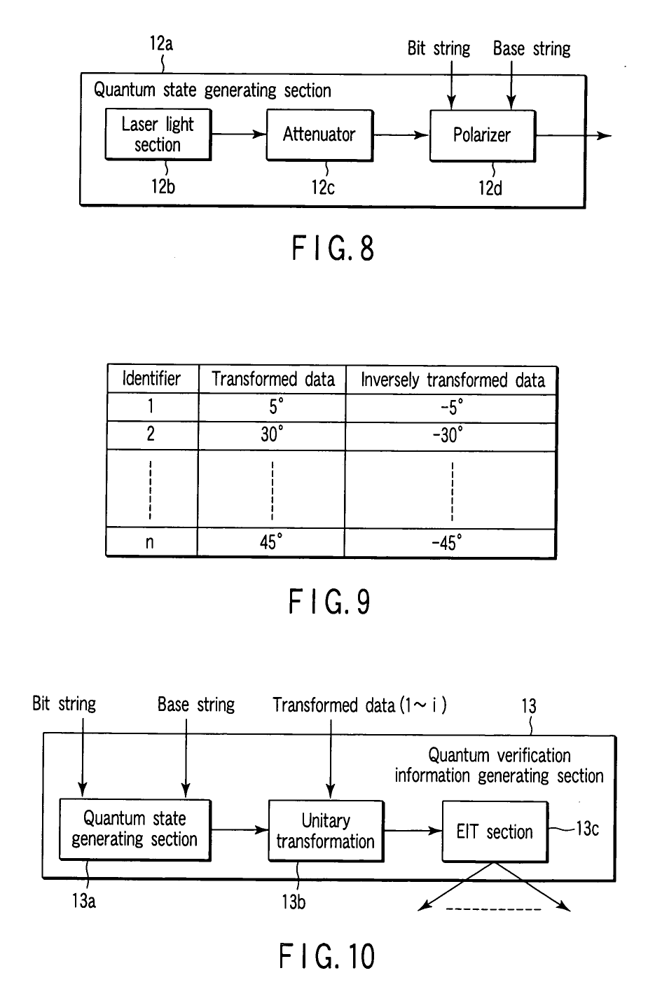

Now, FIG. 7 shows the quantum cash generating section 12 according to the present specific example. The quantum cash generating section 12 comprises a quantum state generating section 12a and an EIT section 12e. The quantum state generating section 12a generates the quantum state of the quantum cash. FIG. 8 shows the internal configuration of the quantum state generating section 12a. The quantum state generating section 12a comprises a laser light section 12b, an attenuator 12c, and a polarizer 12d. The laser light section 12b emits laser light. The attenuator 12c attenuates laser light emitted by the laser light section 12b. When allowing a photon attenuated by the attenuator 12c to pass through, the polarizer 12d controls the polarizing direction of the photon on the basis of the bit and base strings in the input original data. The polarizer 12d thus outputs a photon having one of the four quantum states (polarizing directions). The EIT section 12e uses EIT to hold, in a solid, the quantum state of the photon output by the polarizer 12d. The solid in which the quantum state is held using EIT is called an EIT solid.

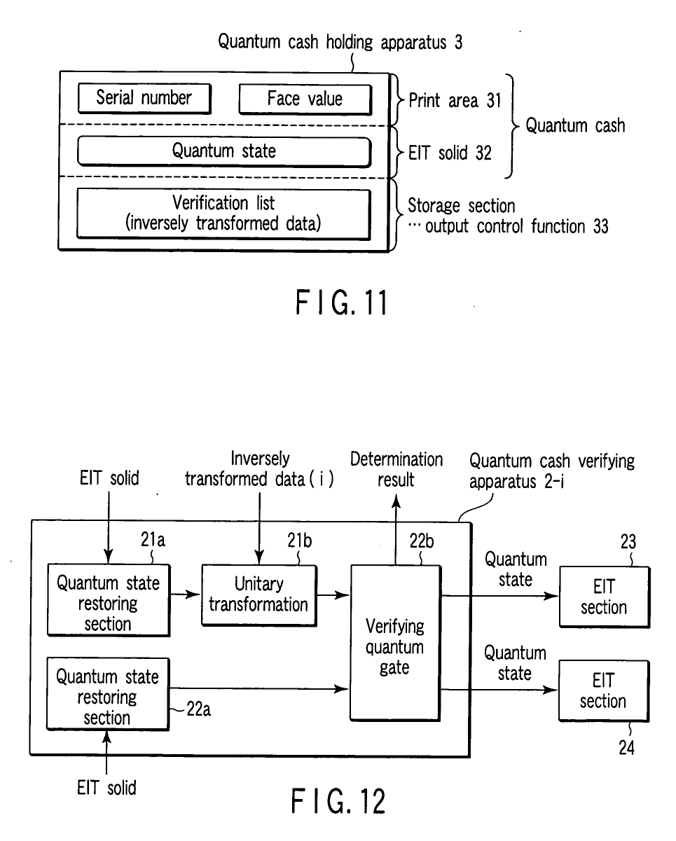

Transformed data are transformation parameters provided for a predetermined unitary transformation and are each provided to a corresponding one of the quantum cash verifying sections 2-1 . . . 2-n as different values. On the other hand, inverse transformation data are transformation parameters provided for the predetermined unitary transformation to cancel the transformation executed using the transformation data. The unitary transformation in the present specific example assumes angular transformation. The transformation parameters and the inverse transformation parameters are stored in association with uniquely identifiable identifiers. The identifiers identify the respective quantum cash verifying apparatuses 2-1 . . . 2-n (FIG. 9 shows an example of the relationship between the identifiers, transformation data, and inverse transformation data).

Now, the configuration of the quantum verification information generating section 13 will be described with reference to FIG. 10. The quantum verification information generating section 13 generates different pieces of quantum verification information individually for the respective quantum cash verifying apparatuses 2-1 . . . 2-n. The quantum verification information generating section 13 comprises a quantum state generating section 13a, a unitary transforming section 13b, an EIT section 13c. The quantum state generating section 13a has the same configuration as that of the quantum state generating section 12a. The EIT section 13c has the same configuration as that of the EIT section 12e. The unitary transforming section 13b allows photon states output by the quantum state generating section 12a to operate sequentially (in this case, angular transformation) on the basis of sequentially provided transformation data. The EIT section 13c holds the photon states sequentially obtained in separate EIT solids.

To implement the unitary transformation into photon states, for example, a half beam splitter may be used. The half beam splitter is described in detail in the document [M. A. Nielsen and I. Chuang, “Quantum Computation and Quantum Information”, Cambridge Univ., 2000, Chap. 7.4.2 (pp. 290 to 296)]. As described above, EIT solids can be generated which hold different verifying quantum states for the respective quantum cash verifying apparatuses 2-1 . . . 2-n.

The verification list generating section 14 generates a list of inverse transformation data and identifiers stored in association with one another.

A quantum cash issuing section (not shown) issues the serial number and face value corresponding to the original data in the storage section 11, the EIT solid generated by the quantum cash generating section 12 on the basis of the original data, and the verification list generated by the verification list generating section 14; the serial number and face value, the EIT solid, and the verification list are issued in the form of a quantum cash holding apparatus 3 such as the one shown in FIG. 11.

The quantum cash holding apparatus 3 may be shaped like a card such as an IC card. The quantum cash holding apparatus 3 comprises a print area 31 on which the serial number and face value are printed on the front surface, an EIT solid 32 that stores the quantum state corresponding to the face value, and a storage section 33 such as EEPROM which stores the verification list for the quantum state. It is assumed that the EIT solid 32 is, for example, attached to the card so as to be buried in it. However, the present invention is not limited to this. The quantum cash holding apparatus 3 is issued only once for one quantum state (EIT solid). The quantum cash holding apparatus 3 thus issued may be called a quantum cash card.

The quantum cash holding apparatus 3 comprises a function for, after the output of the inverse transformation data corresponding to the identifier for the quantum cash verifying apparatus 2-i in the verification list, deleting the inverse transformation data corresponding to the other quantum cash verifying apparatuses 2-1 to 2-(i−1) and 2-(i+1) to 2-n so that the inverse transformation data cannot be restored.

On the other hand, the EIT solids generated by the quantum verification information generating section 13 are distributed to the quantum cash verifying apparatuses 2-1 . . . 2-n corresponding to the respective identifiers. The distribution involves concrete objects and may be carried out, for example, by mail.

Now, the quantum cash verifying apparatuses 2-1 . . . 2-n will be described. All the quantum cash verifying apparatuses 2-2 . . . 2-n have the same configuration. Accordingly, the quantum cash verifying apparatus 2-1 will be described below.

The quantum cash is verified by checking the quantum state. Specifically, a base string of the polarizing direction and a random bit string buried on the basis of the base string are prepared. Then, a photon obtained by restoring the EIT solid of the quantum cash is measured using the polarization base. The system checks whether or not the measurement matches the prepared bit string. If the quantum state is valid, these always match. For a different quantum state, a mismatch is found at a specified probability. For example, when a single photon is focused on and if the bit held by the quantum cash verifying apparatus 2-1 is a polarization of 0°, the probability at which the measurement matches the bit string is 100% if the polarization of the quantum cash is 0°, 50% if the polarization of the quantum cash is −45° or 45°, and 0% if the polarization of the quantum cash is 90°. That is, when the single photon is focused on and if the value and base of one bit of the quantum information on the quantum cash are randomly selected, the probability at which different quantum information (polarizing direction) is mistakenly determined to be “correct” is one-fourth.

The quantum cash verifying apparatus 2-i has a large number of verifying EIT solids distributed every time the quantum cash issuing apparatus 1 issues quantum cash, in association with the as-issued serial numbers. When the user presents the quantum cash holding apparatus 3, one of the EIT solids is identified on the basis of the serial number printed on the front surface of the quantum cash holding apparatus 3.

The quantum cash verifying apparatus 2-i comprises quantum state restoring sections 21a and 22a, a unitary transforming section 21b, and a verifying quantum gate 22b.

The quantum state restoring section 21a restores a photon state from the EIT solid identified on the basis of the serial number. The quantum state restoring section 21a then inputs the photon state obtained to the unitary transformation section 21b. On the basis of the inverse transformation data corresponding to the identifier of the quantum cash verifying apparatus 2-i in the quantum cash holding apparatus 3, the unitary transformation section 21b executes a unitary transformation on the input photon state to generate a new photon state. The unitary transformation section 21b then inputs the photon state obtained to the verifying quantum gate 22b. On the other hand, the quantum state restoring section 22a restores a photon state from the EIT solid attached to the quantum cash card. The quantum state restoring section 22a inputs the photon state obtained to the verifying quantum gate 22b.

The verifying quantum gate 22b compares the polarizing direction of the photon state from the unitary transformation section 21b with the polarizing direction of the photon state from the quantum state restoring section 22a. The verifying quantum gate 22a checks whether or not the two polarizing directions match.

The verifying quantum gate 22b can be implemented by a combination of an Hadamard gate and a swap gate as well known from the document [H. Buhrman, R. Cleve, J. Watrous, and R. de Wolf, Phys. Rev. Lett., 87, 167902 (2003)]. With a single photon source and a single photon detector, the Hadamard gate and swap gate can be constructed using only linear optical elements as well known from the document [E. Knill, L. Laflamme, and G. J. Milburn, Nature 409, 46 (2001)]. Accordingly, the description of these gates is omitted.

The quantum states from the verifying quantum gate 22b correspond exactly to the photon state from the unitary transformation section 21b and the photon state from the quantum state restoring section 22a. The two quantum states are held in the EIT solid by the EIT sections 23 and 24 and are stored in association with the above serial number and face value so as to form a set. When the quantum states match perfectly in the verifying quantum gate 22b, the validity of the quantum cash card is guaranteed. After the validity is guaranteed, the quantum cash verifying apparatus 2-i pays the value printed on the quantum cash card to the user. The quantum cash verifying apparatus 2-i can determine whether or not the two quantum states match but cannot determine the quantum states themselves. This ensures the impossibility of forgery of the quantum cash

After the payment, the quantum cash verifying apparatus 2-i settles the quantum cash for the quantum cash issuing apparatus 1. The settling process may be executed mainly using one of the two methods described below.

A first method involves bringing the stored set of the serial number, face value, and EIT solid to the quantum cash issuing apparatus 1 for verification.

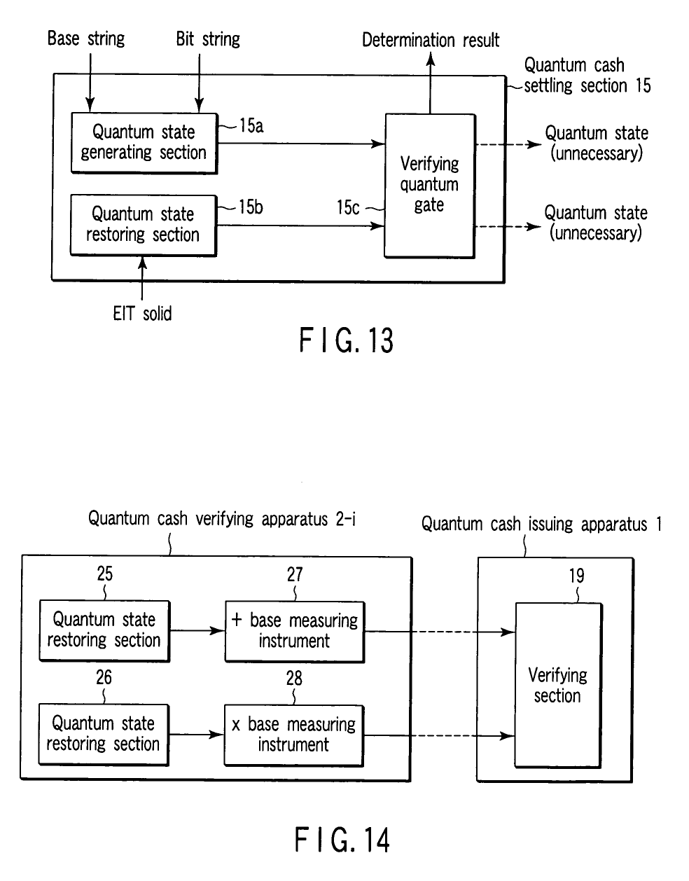

FIG. 13 shows the functional blocks of the setting section 15 of the quantum cash issuing apparatus 1.

On the serial number, the quantum cash issuing apparatus 1 identifies the original data stored in the storage section 11. The quantum cash issuing apparatus 1 supplies the quantum state generating section 15a with the base string and bit string constituting the original data. The quantum state generating section 15a generates a quantum state from the base string and bit string. This results in the generation of perfectly the same quantum state as that generated when the quantum cash was issued.

Further, the quantum state restoring section 15b generates a quantum state from one of the two EIT solids. The verifying quantum gate 15c checks whether or not these quantum states match. Verification is similarly carried out on the other EIT solid.

If each of the two verifications results in a match, the quantum cash issuing apparatus 1 determines that the quantum cash verifying apparatus 2-i has appropriately executed the advance process. The quantum cash issuing apparatus 1 pays the value to the quantum cash verifying apparatus 2-1, which has already paid the value for the quantum cash issuing apparatus 1. This completes the settling process.

Now, description will be given of a second method for the setting process. With the second method, the quantum cash verifying apparatus 2-i transforms the stored set of the serial number, face value, and two EIT solids into electronic information before the quantum cash issuing apparatus 1 verifies the information.

FIG. 14 shows a function for transformation into electronic information which function is provided in the quantum cash verifying apparatus 2-i.

In the quantum cash verifying apparatus 2-i, the two quantum state restoring sections 25 and 26 individually obtain two photon states from the set of the EIT solids on which settlement is to be carried out. The quantum state restoring sections 25 and 26 then input the photon states to a + base measuring instrument 27 or an × base measuring instrument 28. The + base measuring instrument 27 measures the polarized state of one of the photon states on the basis of the + base. The × base measuring instrument 28 measures the polarized state of the other photon state on the basis of the × base. Subsequently, the quantum cash verifying apparatus 2-i uses a transmitting section (not shown) to transmit all the measurements to the quantum cash issuing apparatus 1.

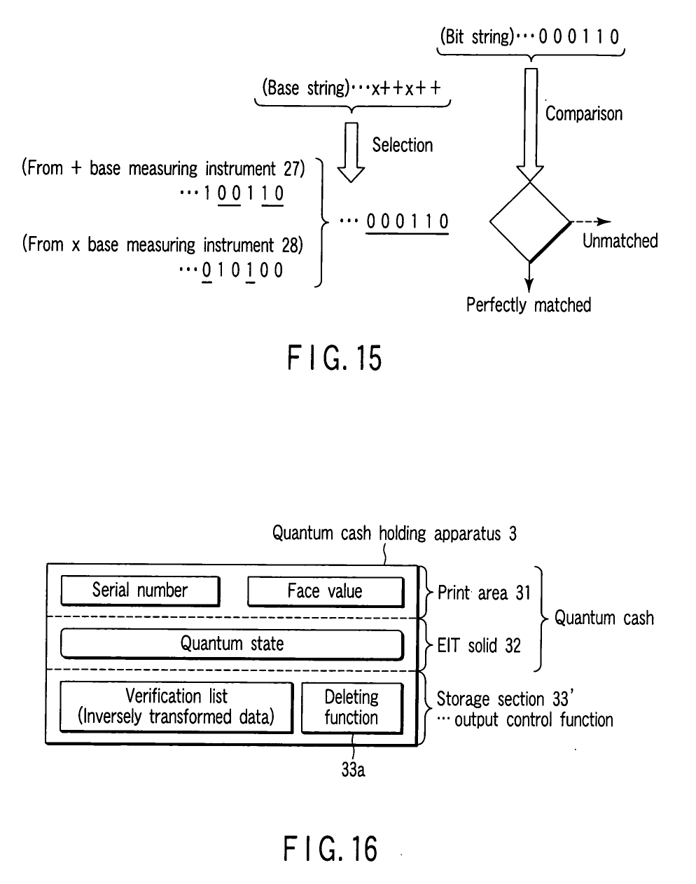

The quantum cash issuing apparatus 1 inputs all the received measurements as well as the base and bit strings of the original data from the storage apparatus 11 to a verifying section 19. The quantum cash issuing apparatus 1 thus determines that the measurements are valid. Specifically, as shown in FIG. 15, for each bit of the base string, either the measurement based on the + base or the measurement based on the × base is selected. The value of the measurement is compared with the corresponding bit value in the bit string to determine whether or not they match. No determination is made on the measured bit values for the unselected base. This is executed on all the measurements. If all the measurements match the corresponding bit values, the quantum cash issuing apparatus 1 determines that the quantum cash is valid. If even one bit fails to match the corresponding measurement, the quantum cash issuing apparatus 1 determines that the quantum state is invalid. The probability of incorrect photons with different polarizing directions being mistakenly determined to be correct is one-fourth per photon. Thus, a sufficiently large number of photons make it possible to reduce the probability of incorrect determinations to a given value. Further, the quantum no-cloning theorem ensures the impossibility of forgery of the quantum cash.

The above verifying technique uses the technique for holding the quantum states from the verifying quantum gate 22b in the EIT solids. However, the present invention is not limited to this. A technique called quantum teleportation can be used to transfer the quantum states from the verifying quantum gate 22b to the quantum cash issuing apparatus 1 as they are. The transfer based on quantum transportation is advantageously secure. The quantum transportation is described in detail in the document [M. A. Nielsen and I. Chuang, “Quantum Computation and Quantum Information”, Cambridge Univ., 2000, Chap. 1.3.7 (pp. 26 to 28)].

In any way, the quantum cash issuing apparatus 1 determines that the quantum state received from the quantum cash verifying apparatus 2-1 is valid, it pays the money required to realize the face value to a quantum cash verification paying function.

The above specific example can produce the effects of the first embodiment. In particular, even when the system comprises the plurality of quantum cash verifying apparatuses 2-1 . . . 2-n, separated from the quantum cash issuing apparatus 1, the quantum cash verifying apparatuses can carry out verifications while avoiding dangers such as cloning and forgery. This makes it possible to provide a quantum cash system that is convenient to the user.

Further, the quantum cash holding apparatus 3 comprises the function for, after the output of the inverse transformation data corresponding to the identifier for the quantum cash verifying apparatus 2-i in the verification list, deleting the inverse transformation data corresponding to the other quantum cash verifying apparatuses 2-1 to 2-(i−1) and 2-(i+1) to 2-n so that the inverse transformation data cannot be restored. This makes it possible to prevent the illegal act in which quantum cash is forged utilizing the quantum states held by the plurality of quantum cash verifying apparatuses 2-1 to 2-n. This deleting function will be described in detail in a third embodiment described below.

### Third Embodiment

FIG. 16 is a schematic diagram showing the configuration of a quantum cash holding apparatus applied to a quantum cash system according to the third embodiment of the present invention. The same parts of this quantum cash holding apparatus as those shown in FIG. 11 will have the same reference numerals. Their detailed description is thus omitted and those parts of the quantum cash holding apparatus which are different from those in FIG. 11 will be mainly described. Duplicate descriptions will be similarly omitted in the following embodiments.

That is, the present embodiment is a specific example of the first or second embodiment. The present embodiment inhibits illegal acts using the quantum cash holding apparatus 3. Specifically, the system comprises a storage section 33′ with a deleting function (output inhibiting device) 33a as a part of an output control section of the above storage section 33.

Here, after the output of the inverse transformation data corresponding to the identifier i for the quantum cash verifying apparatus 2-i from the verification list store in an internal memory of the storage section 33′, the deleting function 33a deletes, from the verification list, the inverse transformation data corresponding to the identifiers 1 to (i−1) ands (i+1) to n for the other quantum cash verifying apparatuses 2-1 to 2(i−1) and 2-(i+1) to 2-n.

The deleting function 33a is not limited to the deletion of the inverse transformation data but may be modified to a function for changing the inverse transformation data to an invalid value such as zero. Alternatively, the deleting function 33a may be modified to a function for deleting the identifiers or changing each of the identifiers to an invalid value. That is, the deleting function 33a is an example of a function for, after the inverse transformation data identified by a certain identifier i has been output from the verification list, inhibiting the output of the inverse transformation data identified by the other identifiers. For supplementation, the deleting function 33a is not limited to the function for deleting and/or rewriting data in the verification data but may be modified to a function for neglecting an instruction on reading of the inverse transformation data.

With the above configuration, in order to allow the quantum cash to be validly used, the quantum cash holding apparatus 3 outputs one of the inverse transformation data and then inhibits the output of the other inverse transformation data in the verification list. This prevents the outflow of the other inverse transformation data, required for the forgery of the quantum cash. It is thus possible to inhibit even the forgery in which the quantum verification information is transformed using the inverse transformation data, thus improving security.

That is, it is possible to utilize the quantum states held by the plurality of quantum cash verifying apparatuses to prevent the illegal act in which quantum cash is forged. In one of the preventable illegal acts, after quantum cash is used, a unitary transformation is executed on the quantum verification information held by another quantum cash verifying apparatus i, on the basis of the inverse transformation data. Then, the original data obtained is reused for yet another quantum cash verifying apparatus 2-k as a part of the quantum cash.

### Fourth Embodiment

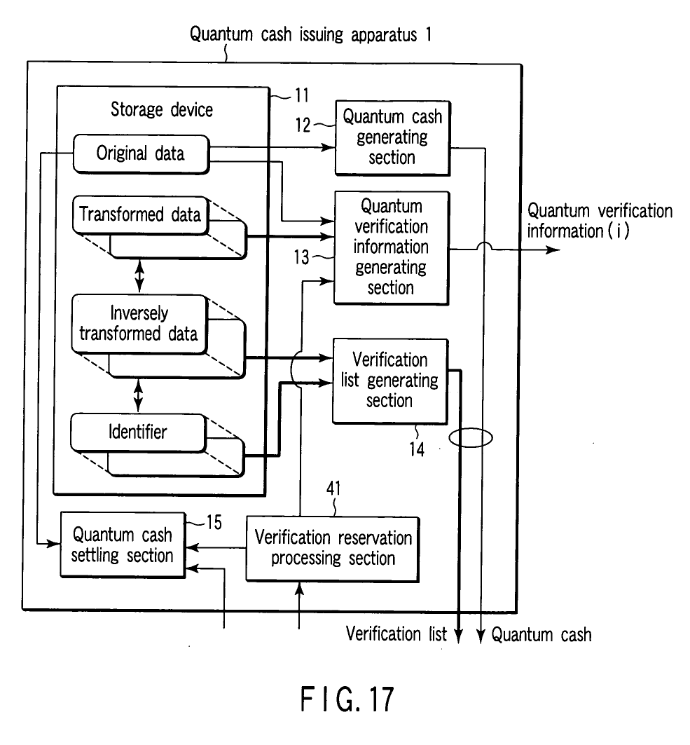

FIG. 17 is a schematic diagram showing the configuration of a quantum cash issuing apparatus applied to a quantum cash system according to a fourth embodiment of the present invention.

That is, the present embodiment is a variation of the first to third embodiments and inhibits a plurality of quantum cash verifying apparatuses from conspiring to commit an illegal act. Specifically, the present invention omits the arrangement in which quantum cash verification information is pre-distributed to all the quantum cash verifying apparatuses 2-1 to 2-n as in the case of the first to third embodiments. Instead, the quantum cash issuing apparatus 1 comprises a verification reservation processing section 41 that, when the quantum cash verifying apparatus 2-i executes or reserves verification, distributes the quantum cash verification information only to the quantum cash verifying apparatus 2-i on demand.

In this case, the verification reservation processing section 41 has a function executed upon receiving an identifier and a quantum verification information request from the quantum cash verifying apparatus 2-i in connection with verification of the quantum cash or the preceding reservation for the verification. The function distributes, to the quantum cash verifying apparatus 2-i, quantum verification information (i) transformed using the transformation data corresponding to the inverse transformation data identified by this identifier.

Specifically, the distributing function uses a method of controlling the quantum verification information generating section 13 during distribution so that the quantum verification information generating section 13 generates and distributes quantum verification information.

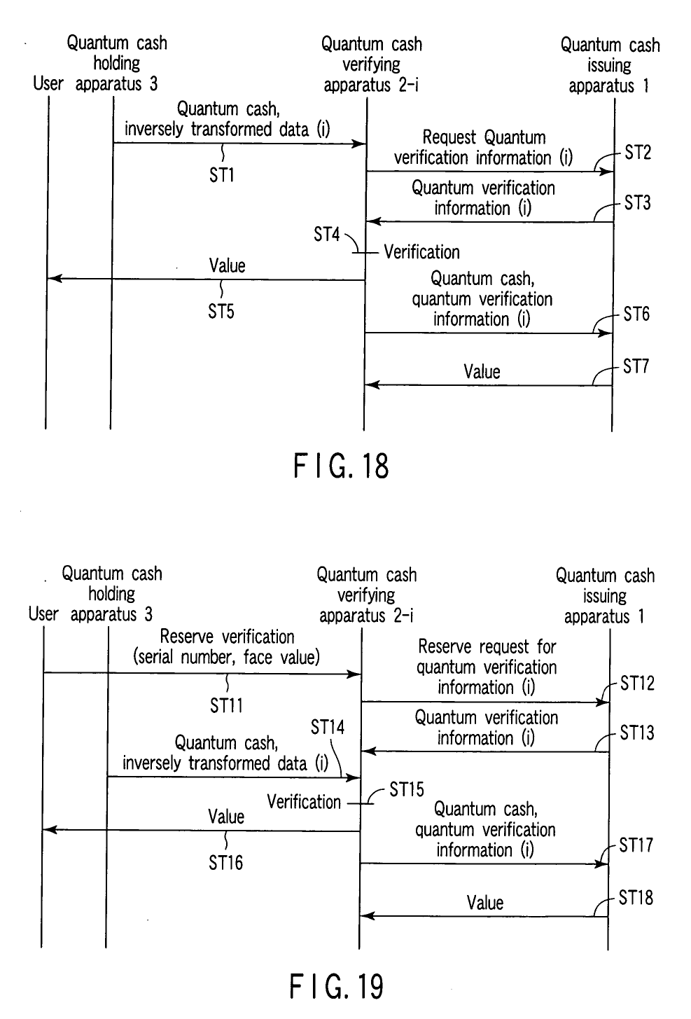

Now, with reference to the sequence diagram in FIG. 18, description will be given of operations of the quantum cash system configured as described above. In this case, description will be given of operations performed if verification is requested immediately before it must be executed as well as operations performed if a reservation is made through a reservation according to a fifth embodiment described below.

When the user pays quantum cash, the quantum cash holding apparatus 3 outputs the quantum cash and inverse transformation data (i) to, for example, the quantum cash verifying apparatus 2-1 (ST1).

Upon receiving the quantum cash and inverse transformation data (i), the quantum cash verifying apparatus 2-i transmits its own identifier i and a request for the quantum verification information (i) to the quantum cash issuing apparatus 1 in order to verify the quantum cash (ST2).

When the quantum cash issuing apparatus 1 receives the identifier and the request for the quantum verification information (i), the verification reservation processing section 41 controls the quantum verification information generating section 13. The quantum verification information generating section 13 transforms the original data using the transformation data corresponding to the inverse transformation data identified by the identifier. The quantum verification information generating section 13 then distributes the quantum verification information (i) obtained to the quantum cash verifying apparatus 2-i (ST3).

The quantum cash verifying apparatus 2-i verifies the quantum cash on the basis of the quantum verification information (i) (ST4) and outputs the result of the verification. When the quantum cash can be determined to be valid on the basis of the result of the verification, the user is provided with the value set for the quantum cash (ST5).

Then, as previously described, the quantum cash verifying apparatus 2-i requests the quantum cash issuing apparatus 1 to execute a setting process on the basis of the set of two quantum states resulting from the verification (ST6).

The quantum cash verifying apparatus 1 uses the previously described quantum cash settling section 15 to verify the validity of the quantum cash. If the quantum cash is determined to be valid, the quantum cash issuing apparatus 1 considers that the user has been provided with the consideration set for the quantum cash. The quantum cash issuing apparatus 1 thus provides the value for which the advance has been paid (ST7).

As described above, the present embodiment not only produces the effects of the first to third embodiments but also distributes quantum verification information only to the quantum cash verifying apparatus 2-i that actually verifies the quantum cash, while avoiding distributing the quantum verification information to the other quantum cash verifying apparatuses 2-1, . . . , 2-(i−1), 2-(i+1), . . . 2-n. This makes it possible to further improve security. Furthermore, it is possible to reduce the total amount of communication and thus the possibility of eavesdropping.

### Fifth Embodiment

Now, description will be given of a quantum cash system according to a fifth embodiment of the present invention.

The present embodiment is a variation of the fourth embodiment. In the description of the present embodiment, the verification reservation processing section 41 avoids requesting quantum verification information immediately before it becomes necessary and instead makes a reservation for a request for quantum verification information. In this case, the reservation may involve an arbitrary communication form, for example, the use of the Internet. This type of communication form enables the use of the previously described mutual authentication system based on the public key ciphering as required.

Further, the verification reservation processing section 41 comprises a function corresponding to cancellation of reservations. The function corresponding to the cancellation of reservations comprises, for example, the following functions so as to cancel a reservation for verification: a function for, upon receiving an identifier and quantum verification information (i), using the verifying function of the quantum cash settling section 15 to confirm that the quantum verification information (i) is genuine on the basis of the inverse transformation data identified by the identifier and a function for, after the confirmation, approving the cancellation of the reservation.

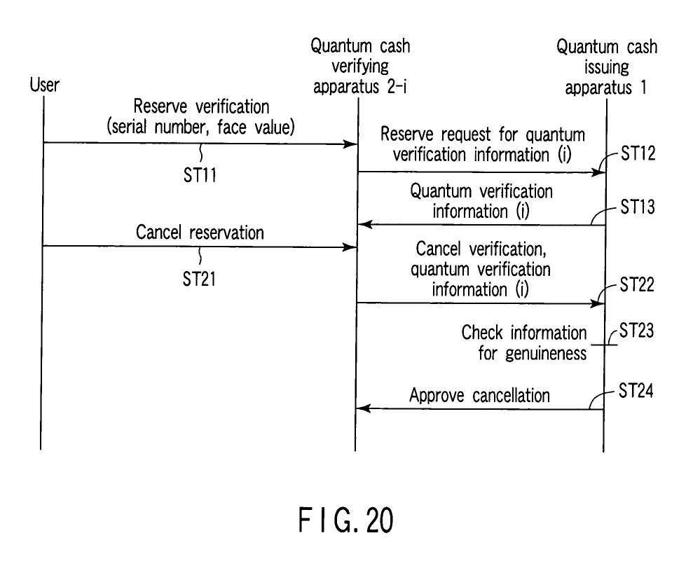

Now, with reference to the sequence diagrams in FIGS. 19 and 20, description will be given of operations of the quantum cash system configured as described above.

(Verification Reserving Process)

By, for example, operating a terminal (not shown), the user transmits a verification reservation to the quantum cash verifying apparatus 2-i; the reservation contains the serial number and face value described on the quantum cash holding apparatus 3 (ST11).

Upon receiving the verification reservation, the quantum cash verifying apparatus 2-i transmits its own identifier and a reservation for a request for the quantum verification information (i) to the quantum cash issuing apparatus 1 (ST12).

Upon receiving the identifier and reservation, the quantum cash issuing apparatus 1 stands by until the reserved date and time. At the reserved time, as in the case of ST3, described above, the quantum cash issuing apparatus 1 controls the quantum verification information generating section 13 so that the quantum verification information generating section 13 transforms the original data using the transformation data corresponding to the inverse transformation data identified by the identifier. The quantum verification information generating section 13 then distributes the quantum verification information (i) obtained to the quantum cash verifying apparatus 2-i (ST14).

Then, as in the case of steps ST4 and ST5, previously described, the quantum cash verifying apparatus 2-i verifies the quantum cash and provides the value if the quantum cache is determined to be valid (ST 15 and ST16).

Further, as in the case of ST6 and ST7, previously described, the quantum cash verifying apparatus 2-i requests a settling process (ST17). Moreover, the quantum cash issuing apparatus 1 verifies the validity and provides the value.

(Verification Reservation Canceling Process)

Now, as shown in FIG. 20, it is assumed that the processing in steps ST11 to ST13 is executed as in the case of FIG. 19, previously described.

However, in contrast to the previous description, the user notifies the quantum cash verifying apparatus 2-i that the reservation will be cancelled as shown in FIG. 20 (ST21).

In this case, the quantum cash verifying apparatus 2-i returns its own identifier and the quantum verification information (i) to the quantum cash issuing apparatus 1 so as to cancel the reservation for verification (ST22).

Upon receiving the identifier and quantum verification information (i), the quantum cash issuing apparatus 1 controls the quantum cash settling section 15 so that the quantum cash settling section 15 confirms the genuineness of the quantum verification information (i) on the basis of the inverse transformation data identified by the identifier (ST23).

After the confirmation, the verification reservation processing section 41 of the quantum cash issuing apparatus 1 approves the cancellation of the reservation.

As described above, according to the present embodiment, the arrangement that requests quantum verification information through a reservation can not only produce the effects of the fourth embodiment but also reduce the time required for the verification.

Moreover, in canceling the reservation, the arrangement that confirms the genuineness of the quantum cash verification information (i) enables the canceling process to be securely completed.

The techniques described in the embodiments can be partly stored, as programs that can be executed by a computer, in storage media such as a magnetic disk (floppy (registered trade mark) disk, hard disk, or the like), an optical disk (CD-ROM, DVD, or the like), a magneto-optic disk (MO), or a semiconductor memory.

The storage media may be in any form provided that it can store programs and can be read by the computer.

An operating system (OS) or middleware such as database management software or network software may execute part of the processes required to implement the present embodiment; the OS operates on the computer on the basis of instructions from a program installed in the computer.

The storage media according to the present invention is not limited to media independent of the computer but includes storage media in which programs transmitted over the Internet or the like are permanently or temporarily stored by downloading.

The number of storage media is not limited to one. The storage media according to the present invention includes the execution of the process according to the present embodiment from a plurality of media. The media may be arbitrarily configured.

The computer according to the present invention executes the processes according to the present embodiment on the basis of the programs stored in the storage media. The computer may be arbitrarily configured; it may comprise one apparatus similarly to a personal computer or may be a system in which a plurality of apparatuses are connected together via a network.

The computer according to the present invention is not limited to a personal computer but includes an arithmetic processing apparatus, a microcomputer, or the like contained in information processing equipment. The computer is a general term for equipment and apparatuses that can realize the functions of the present invention using programs.

The present invention is not limited to the as-described embodiments. In implementation, the present invention can be embodied by varying the components of the embodiments without departing from the spirit of the present invention. Further, various inventions can be formed by appropriately combining a plurality of the components disclosed in the embodiments. For example, some of the components shown in the embodiments may be omitted. Moreover, components of different embodiments may be appropriately combined together.

As described above, the quantum cash system and quantum cash apparatus are useful in inhibiting even forgery in which quantum verification information is transformed using inverse transformation data, thus improving security.

1. A quantum cash system comprising:
a quantum cash issuing apparatus which issues quantum cash including a first quantum state corresponding to original data indicating at least the amount of money, a plurality of pieces of quantum verification information including second quantum states obtained by individually transforming the first quantum state on the basis of a plurality of transformation data, the quantum verification information being used to verify the first quantum state, and a verification list having a plurality of inverse transformation data used to inversely transform the quantum verification information in association with the transformation data and identifiers that can identify the inverse transformation data;
a quantum cash holding apparatus which holds the quantum cash and the verification list and which can output the quantum cash and one of the inverse transformation data in the verification list; and
a quantum cash verifying apparatus to which the identifier is assigned and which, upon receiving the quantum cash, inverse transformation data, and identifier from the quantum cash holding apparatus, can verify the first quantum state of the quantum cash on the basis of first quantum information obtained by transforming second quantum information of the quantum verification information using the inverse transformation data,
wherein the quantum cash holding apparatus comprises:
an output device configured to output of one of the inverse transformation data; and
an output inhibiting device configured to inhibit output of the other inverse transformation data in the verification list.

2. The quantum cash system according to claim 1, wherein the output inhibiting device comprises:
a deleting function unit configured to delete the other inverse transformation data so as to inhibit the output.

3. The quantum cash system according to claim 1, wherein the quantum cash issuing apparatus comprises:
a first receiving device configured to receive an identifier and a quantum verification information request from the quantum cash verifying apparatus in connection with verification of the quantum cash or a reservation for the verification;
a verification information distributing device configured to distribute, to the quantum cash verifying apparatus, quantum verification information transformed using transformation data corresponding to inverse transformation data identified by the identifier.

4. The quantum cash system according to claim 3,
wherein the quantum cash issuing apparatus comprises:
a second receiving device configured to receive the identifier and quantum verification information from the quantum cash verifying apparatus, so as to cancel the reservation for the verification;
a genuineness confirming device configured to confirm genuineness of the quantum verification information on the basis of the inverse transformation data identified by the identifier, the quantum verification information and the identifier being received by the second receiving device; and
an approving device configured to approve cancellation of the reservation after the confirmation.

5. A quantum cash holding apparatus used in a quantum cash system, the quantum cash system comprising:
a quantum cash issuing apparatus which issues quantum cash including a first quantum state corresponding to original data indicating at least the amount of money, a plurality of pieces of quantum verification information including second quantum states obtained by individually transforming the first quantum state on the basis of a plurality of transformation data, the quantum verification information being used to verify the first quantum state, and a verification list having a plurality of inverse transformation data used to inversely transform the quantum verification information in association with the transformation data and identifiers that can identify the inverse transformation data;
the quantum cash holding apparatus which holds the quantum cash and the verification list and which can output the quantum cash and one of the inverse transformation data in the verification list; and
a quantum cash verifying apparatus to which the identifier is assigned and which, upon receiving the quantum cash, inverse transformation data, and identifier from the quantum cash holding apparatus, can verify the first quantum state of the quantum cash on the basis of first quantum information obtained by transforming second quantum information of the quantum verification information using the inverse transformation data,
wherein the quantum cash holding apparatus further comprises:
an output device configured to output of one of the inverse transformation data; and
an output inhibiting device configured to inhibit output of the other inverse transformation data in the verification list.

6. The quantum cash holding apparatus according to claim 5, wherein the output inhibiting device comprises:
a deleting function unit configured to delete the other inverse transformation data so as to inhibit the output.

7. A quantum cash system comprising:
a quantum cash issuing apparatus which issues quantum cash including a first quantum state corresponding to original data indicating at least the amount of money, a plurality of pieces of quantum verification information including second quantum states obtained by individually transforming the first quantum state on the basis of a plurality of transformation data, the quantum verification information being used to verify the first quantum state, and a verifica-tion list having a plurality of inverse transformation data used to inversely transform the quantum verifica-tion information in association with the transformation data and identifiers that can identify the inverse transformation data;
a quantum cash holding apparatus which holds the quantum cash and the verification list and which can output the quantum cash and one of the inverse transformation data in the verification list; and
a quantum cash verifying apparatus to which the identifier is assigned and which, upon receiving the quantum cash, inverse transformation data, and identifier from the quantum cash holding apparatus, can verify the first quantum state of the quantum cash on the basis of first quantum information obtained by transforming second quantum information of the quantum verification information using the inverse transformation data,
wherein the quantum cash issuing apparatus further comprises:
a first receiving device configured to receive an identifier and a quantum verification information request from the quantum cash verifying apparatus in connection with verification of the quantum cash or a reservation for the verification;
a verification information distributing device configured to distribute, to the quantum cash verifying apparatus, quantum verification information transformed using transformation data corresponding to inverse transformation data identified by the identifier.

8. The quantum cash system according to claim 7, wherein the quantum cash issuing apparatus further includes:
a second receiving device configured to receive the identifier and quantum verification information from the quantum cash verifying apparatus, so as to cancel the reservation for the verification;
a genuineness confirming device configured to confirm genuineness of the quantum verification information on the basis of the inverse transformation data identified by the identifier, the quantum verification information and the identifier being received by the second receiving device; and
an approving device configured to approve cancellation of the reservation after the confirmation.
